(19) United States
(12) Patent Application Publication
(10) Pub. No.: US 2024/0351419 A1
(43) Pub. Date: Oct. 24, 2024

(54) ELECTRIC VEHICLE BATTERY SWAPPING ASSEMBLY AND BATTERY SWAPPING STATION

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); Xinrui Yu, Shanghai (CN); Danliang Qiu, Shanghai (CN); Chunhua Huang, Shanghai (CN); Ming Zhu, Shanghai (CN)

(21) Appl. No.: 18/575,825

(22) PCT Filed: Nov. 30, 2022
(86) PCT No.: PCT/CN2022/135552

§ 371 Date: Dec. 30, 2023

(30) Foreign Application Priority Data
Nov. 30, 2021 (CN) 202111444383.8
Dec. 26, 2021 (CN) 202111606763.7
Dec. 26, 2021 (CN) 202111606781.5
Dec. 31, 2021 (CN) 202111668032.5

(51) Int. Cl. B60K 1/04; B60L 53/80; H01M 50/249

(52) U.S. Cl. CPC B60K 1/04; B60L 53/80; H01M 50/249; B60K 2001/0438

(57) ABSTRACT

Discloses an electric vehicle battery swapping assembly and battery swapping station. An electric vehicle battery swapping assembly comprises a battery swapping equipment and a battery pack box, both the battery swapping equipment and the battery pack box are arranged at the bottom of the electric vehicle, and the battery pack box is removed or installed from the bottom of the electric vehicle by means of the battery swapping equipment, during the removal or installation process, the height of the electric vehicle is unchanged, and the bearing plane for carrying the battery swapping equipment and the bearing plane for carrying the electric vehicle are in the same plane. The invention does not need to lift the vehicle or dig a hole on the ground to set up the battery swapping equipment, which improves the safety of the battery swapping station and can improve the battery swapping efficiency.

This application claims the priority of Chinese patent application CN2021116680325 on Dec. 31, 2021, the priority of Chinese patent application CN2021116067637 on Dec. 26, 2021, and the priority of Chinese patent application CN2021116067815 on Dec. 26, 2021, and the priority of the Chinese patent application CN2021114443838 on Nov. 30, 2021. This application cites the full text of the Chinese patent applications as mentioned above.

### TECHNICAL FIELD

The invention relates to the field of electric vehicle battery swapping technology, in particular to an electric vehicle battery swapping assembly and battery swapping station.

### BACKGROUND

The battery swapping station is used to swap the battery of the electric vehicle, and the electric vehicle drives into the battery swapping platform in the battery swapping station, and the battery swapping equipment of the battery swapping station removes the insufficiently charged battery from below the battery swapping vehicle, and installs the fully charged battery on the electric vehicle. In the prior art, for electric vehicles, such as heavy trucks, the battery pack is placed above the vehicle beam, and the battery is transported and swapped by means of the top spreader during battery swapping, in this way, the center of the battery pack is relatively high relative to the vehicle beam, which has potential safety hazards, however, for the way that the battery pack is installed at the bottom of the vehicle, it is generally necessary to raise the electric vehicle or dig a hole on the ground for the battery swapping equipment to enter and exit the bottom of the vehicle to remove and install the battery pack, which leads to high cost, great difficulty and high requirements for the site, and the battery swapping efficiency is low, especially for heavy trucks, which is tens of tons, the existing lifting equipment is difficult to meet the demand of raising the vehicle body, and it needs a larger floor larger area when digging holes on the ground, and the vehicle is easy to collapse when passing through the area near the pit.

### CONTENT OF THE PRESENT INVENTION

The technical problem to be solved by the invention is to overcome the defects of high difficulty, high cost, long period and potential safety hazards caused by raising the vehicle body or digging holes in the ground when replacing the battery in the chassis of electric vehicle in the prior art, and to provide an electric vehicle battery swapping and battery swapping station which are suitable for heavy electric vehicles and have low construction difficulty.

The present invention solves the above technical problems through the following technical solution:

An electric vehicle battery swapping assembly, the electric vehicle battery swapping assembly comprises a battery swapping equipment and a battery pack box, wherein both the battery swapping equipment and the battery pack box are arranged at the bottom of the electric vehicle, and the battery pack box is removed or installed from the bottom of the electric vehicle by means of the battery swapping equipment, and the height of the electric vehicle is unchanged during the removal or installation process, and the bearing plane for carrying the battery swapping equipment and a bearing plane for carrying the electric vehicle are in the same plane.

In this solution, the battery pack box is used for the built-in battery pack body to provide power for the electric vehicle. The battery swapping equipment is arranged in the battery swapping station. In the process of battery swapping, the unloaded battery swapping equipment drives into the lower part of the electric vehicle, removes the battery pack box with built-in insufficiently charged battery pack body on the electric vehicle, and transports it back to the station for storage, then, the power battery swapping equipment transports the battery pack box with built-in fully charged battery pack body to the lower part of the electric vehicle and installs it on the electric vehicle.

In the process of battery swapping, the bearing plane for carrying battery swapping equipment for the operation of battery swapping equipment and the bearing plane for carrying vehicle for the operation of electric vehicle are in the same plane, and the height of electric vehicle is unchanged, so that the unloaded battery swapping equipment can freely enter and exit the lower part of electric vehicle equipped with battery pack box, and the fully loaded battery swapping equipment can freely enter and exit the lower part of electric vehicle without battery pack box, in other words, the battery swapping assembly of the electric vehicle in this solution can be set on the ground, the lifting of the electric vehicle in the process of battery swapping is avoided, and the pit-digging treatment of the battery swapping station is also avoided, and the battery swapping equipment is set to sink relative to the ground, accordingly, the battery swapping station corresponding to the battery swapping assembly of the electric vehicle in this solution has the effect of low construction cost due to no need to dig a pit for the battery swapping equipment, and the effect of reducing construction difficulty due to no need to lift the electric vehicle.

From the above, it can be seen that the battery swapping station corresponding to the electric vehicle battery swapping assembly in this solution does not need to lift the vehicle or dig a hole on the ground to set up battery swapping equipment, considering the high weight and load of the electric truck itself, the above effect is particularly important for the electric truck, the function of swapping battery of the electric truck on the ground has been achieved by means of the electric vehicle battery swapping assembly, improving the safety of the battery swapping station, improving the battery swapping efficiency, and facilitating drainage.

Preferably, the height of the bottom of the electric vehicle and the battery pack box is set as follows:
Condition 1: when the battery swapping equipment removes the battery pack box, a height of the bottom of the battery pack box from the bearing plane for carrying the battery swapping equipment is greater than a height of the battery swapping equipment when it is unloaded;
Condition 2: when the battery swapping equipment installs the battery pack box, a height of the bottom of the electric vehicle from the bearing plane for carrying the battery swapping equipment is greater than an overall height of the battery swapping equipment when carrying the battery pack box.

In this solution, by setting the height relationship between the bottom of the electric vehicle, the battery swapping equipment and the battery pack box, the effect that the electric vehicle can be swapped battery without lifting the electric vehicle or digging a hole can be achieved. When the electric vehicle is loaded with a battery pack, the center of gravity of the whole vehicle sinks, when the first condition is met, no matter whether the electric vehicle is loaded with a battery pack or not, the unloaded battery swapping equipment can freely enter and exit the bottom of the electric vehicle. When the battery pack box is carried by the battery swapping equipment, the overall height of the two is higher than that of a single battery swapping equipment, when the second condition is met, the battery swapping equipment carrying the battery pack box can freely enter and exit the lower part of the electric vehicle regardless of whether the battery pack is carried on the electric vehicle.

In this solution, the electric vehicle battery swapping assembly meets both conditions 1 and 2, and realizes the swapping operation under the condition that the bearing plane for carrying the battery swapping equipment and the bearing plane for carrying the electric vehicle are in the same plane and the electric vehicle is not lifted. Accordingly, the developers developed these products, such as the battery swapping equipment, the battery pack box, and the connection structure between the battery pack box and the electric vehicle, based on conditions one and two.

Preferably, the electric vehicle comprises a vehicle beam, and the battery pack box body is detachable installed on the vehicle beam by means of a locking mechanism, and the height of the bottom of the vehicle beam from the bearing plane for carrying the battery swapping equipment is greater than the overall height of the battery swapping equipment when carrying the battery pack box.

In this solution, the vehicle beam is used to install the battery pack box, that is, the vehicle beam on the chassis of the electric vehicle itself is used as the carrier for installing the battery pack box, so that the battery pack can be added without changing the structure of the vehicle itself. In practical application, the height of the vehicle beam from the bearing plane for carrying the battery swapping equipment is taken as one of the parameters to develop the battery swapping equipment and battery pack, so as to ensure that the height of the bottom of the vehicle beam from the bearing plane for carrying the battery swapping equipment is greater than the overall height of the battery swapping equipment when carrying the battery pack box.

Preferably, the electric vehicle is an electric truck, and a battery pack box accommodating space is arranged between two sets of wheels of the electric truck along the driving direction, and the height of the vehicle beam at the battery pack box accommodating space is greater than the overall height of the battery swapping equipment when carrying the battery pack box.

In this solution, the space between the two sets of wheels in the driving direction of the electric truck is used to set the battery pack box, which is convenient to control the center of gravity of the whole vehicle in the middle of the electric truck and avoid the risk of top-heavy or top-heavy; for the existing electric truck, the space between the two sets of wheels in the driving direction is larger in the length and width direction compared with other positions, which allows the battery pack box to occupy a larger space, thus allowing the battery pack with higher capacitance to be arranged; reasonable use of the space between the two sets of wheels in the driving direction also improves the compactness of the electric truck structure. The height of the vehicle beam at the accommodation space of the battery pack box is greater than the overall height of the battery swapping equipment when carrying the battery pack box, so that the battery swapping equipment carrying the battery pack box can freely enter and exit the lower part of the vehicle beam to install the battery pack box on the vehicle beam from below.

Preferably, the battery pack box is arranged below the vehicle beam.

In this solution, the battery pack box is arranged below the vehicle beam, so that on the one hand, the center of gravity of the battery pack box is lowered, and the installation safety of the battery pack box on the vehicle is improved; on the other hand, the space below the vehicle beam is used to install the battery pack box, which not only ensures the integrity of the battery pack box, but also does not need to change the structure of the vehicle beam itself to carry a large-size battery pack box, when removing the battery pack box, no-load battery swapping equipment runs from the side of the electric truck to the lower part of the vehicle beam, and the switch of the locking mechanism is lifted by the battery swapping equipment to unlock the locking mechanism from the battery pack box, and the battery pack is seated on the battery swapping equipment, when installing the battery pack box, the fully loaded battery swapping equipment runs from the side of the electric truck to the lower part of the vehicle beam to lift the battery pack box and connect it with the locking mechanism, during the whole removal and installation process, the movement of the battery pack box is not interfered by the vehicle beam and other components of the electric truck, making the removal and installation process convenient and improving the efficiency of battery swapping.

Or, the battery pack box is at least partially overlapped with the vehicle beam in the vertical direction.

In this solution, the lower side of the vehicle beam is partially embedded in the upper end of the battery pack box, so that the height of the battery pack box from the bearing plane for carrying the battery swapping equipment is higher, and a larger space is reserved for the unloaded battery swapping equipment, which is convenient for the unloaded battery swapping equipment to freely enter and exit the space below the vehicle.

Preferably, the locking point of the locking mechanism is arranged below the vehicle beam.

In this solution, the locking point is the position on the locking mechanism that directly connects with the battery pack box and is used to lock the battery pack box, when installing the battery pack box, the battery swapping equipment lifts the battery pack box and connects it with the locking mechanism at the locking point, when removing the battery pack box, the battery swapping equipment lifts the locking mechanism to unlock the connection relationship between it and the battery pack box at the locking point, and the battery pack is seated on the battery swapping equipment, during the whole battery swapping process, because the locking point is located below the vehicle beam, interference between the battery pack box and the vehicle beam is not easy to occur, so that the vehicle beam is not greatly changed, and the large-size battery pack box can be integrally installed on the vehicle beam. The battery swapping equipment only needs to move the battery pack box downward for a short distance to avoid the vehicle beam and the locking mechanism, so as to enter and exit the bottom of the vehicle beam in the horizontal direction, and sufficient space is reserved for the battery swapping equipment to enter and exit the bottom of the vehicle beam, so as to prevent the components on the vehicle from interfering with the entry and exit of the battery swapping equipment.

Or the locking point of the locking mechanism is arranged on the side of the vehicle beam,

That is, the locking point is higher than the lower surface of the vehicle beam at the accommodation space of the battery pack box, correspondingly, in the vertical direction, the vehicle beam and the battery pack box partially overlap, this solution is beneficial to increase the distance from the lower surface of the battery pack box to the bearing plane for carrying the battery swapping equipment, and reserve more space for the battery swapping equipment to improve the safety of the system.

Preferably, the battery pack box comprises a lower box and an upper cover, and the battery pack box is provided with a locking shaft which is detachable connected with the locking mechanism.

In this solution, the upper cover is closed on the lower box to form a space for accommodating the battery pack box body, the locking shaft is installed on the lower box or the upper cover, and a locking point is formed at the connection between the locking shaft and the locking mechanism.

Preferably, the locking shaft is arranged below the surface of the upper cover, the distance of the locking shaft from the highest position of the upper cover is h1, and the distance between the locking point and the bottom of the vehicle beam is h2, and h1 is less than h2.

In this solution, the upper end of the battery pack box is provided with a connecting groove, and a locking shaft is arranged in the connecting groove, after the battery pack box is installed on the vehicle beam, the locking point is inserted into the connecting groove, and the highest position of the upper cover is lower than the vehicle beam.

In this solution, by setting the height above, the interference between the battery pack box and the vehicle beam is avoided when the locking shaft enters the locking point of the locking mechanism, that is, when the locking shaft enters the locking mechanism in the vertical direction, the movement of the battery pack box will not collide with the vehicle beam.

Preferably, the locking shaft is arranged higher than the surface of the upper cover, and the distance of the locking shaft from the surface of the upper cover is h3; when the battery pack is carried by the battery swapping equipment, the sum of the height of the upper cover from the bearing plane for carrying the battery swapping equipment and h3 is smaller than the height of the locking point from the bearing plane for carrying the battery swapping equipment.

In this solution, the battery swapping equipment carrying the battery pack box can freely enter and exit the bottom of the electric vehicle. When installing the battery pack, after the battery swapping equipment is aligned, lift the battery pack box to connect it with the locking mechanism. In this solution, the locking shaft is higher than the surface of the upper cover, and correspondingly, the locking point is also higher than the surface of the upper cover, making it easier for the locking shaft to be installed on or removed from the locking mechanism.

Preferably, the locking mechanism comprises a locking base, and the depth of the locking base entering into the battery pack box is between 39 mm to 100 mm.

In this solution, a locking point is formed on the locking base, and the locking base is detachable connected with the locking shaft, when the locking base and the locking shaft are connected, the battery pack box is locked on the vehicle beam, and when the locking base and the locking shaft are separated, the battery pack box and the vehicle beam are unlocked.

Preferably, the locking base is installed on the side wall of the vehicle beam by means of an installing bracket, and the height of the bottom of the installing bracket from the bearing plane for carrying the battery swapping equipment is greater than the overall height of the battery swapping equipment when carrying the battery pack.

In this solution, the installing bracket is connected to the vehicle beam by means of a fastener, and the locking base is connected to the vehicle beam by means of the installing bracket, so that the existing vehicle can be transformed into an electric vehicle by adding the installing bracket without changing the structure of the existing vehicle, as long as the height of the installing bracket from the bearing plane for carrying the battery swapping equipment is ensured to be greater than the overall height of the battery swapping equipment when carrying the battery pack, the battery swapping equipment can be guaranteed to freely enter and exit the lower part of the vehicle. The installing bracket not only has the function of connecting the battery pack box and the vehicle beam, but also has the function of bearing part of the weight of the battery pack, thus reducing the influence of the battery pack on the rigidity and strength of the vehicle beam.

Preferably, the locking shaft is arranged higher than the surface of the upper cover, and the distance between the locking shaft and the surface of the upper cover is h3; when the battery pack is carried by the battery swapping equipment, the sum of the height of the surface of the upper cover from the battery swapping platform and h3 is smaller than the height of the bottom of the installing bracket from the bearing plane for carrying the battery swapping equipment.

In this solution, the battery swapping equipment carrying the battery pack box can freely enter and exit the bottom of the electric vehicle. When installing the battery pack, after the battery swapping equipment is aligned, lift the battery pack box to connect it with the locking mechanism. In this solution, the locking shaft is higher than the surface of the upper cover, and correspondingly, the locking point is also higher than the surface of the upper cover.

Preferably, the battery pack box further comprises an unlocking linkage mechanism, and the unlocking linkage mechanism penetrates through the battery pack box in the vertical direction.

In this solution, the unlocking linkage mechanism is arranged on the battery pack box for unlocking the battery pack and the locking mechanism on the vehicle; the unlocking linkage mechanism comprises an input end and an output end, and the input end of the unlocking linkage mechanism in the initial state is driven by external equipment to act on the locking mechanism to unlock.

The unlocking process is as follows: the battery swapping equipment in the battery swapping station loads the input end in the preset direction, and the input end pushes the output end to move to unlock the locking mechanism. After the acting force of the battery swapping equipment on the input end disappears, the input end and the output end are reset to the initial state under the action of elastic force.

Because the input end and the output end are elastically connected in the preset direction, when the output end contacts the locking mechanism, the elastic force between the input end and the output end buffers the collision force between the output end and the locking mechanism, thus avoiding hard impact on the locking mechanism, thus contributing to the durability of the output end and the locking mechanism.

In this solution, the preset direction is up and down, that is, the input end and output are set up and down, where the input end is located below and the output end is located above, and the battery swapping equipment pushes the input end to move from below the battery pack.

In this solution, the input end and output end are provided on different members, while in other solutions, the input end and output end can be located on the same member.

A battery swapping station comprises:
the battery swapping platform is used to park electric vehicle for removal and installation of the battery pack;
the battery swapping equipment is used for removing and installing the battery pack of the electric vehicle on the battery swapping platform;
wherein the height of the bottom of the battery pack installed on the electric vehicle from the battery platform is greater than the height of the battery swapping equipment when it is unloaded;

The overall height of the battery swapping equipment when carrying the battery pack is smaller than the height of the bottom of the electric vehicle from the battery swapping platform.

In this solution, the removing process begins, and the unloaded battery swapping equipment directly drives into the battery swapping working position by means of the plane of the battery swapping platform to take down the battery pack of the vehicle body; and after swapping the new battery, the battery swapping equipment carrying the new battery still directly drives into the battery swapping working position by means of the plane of the battery swapping platform to load the new battery to the bottom of the vehicle body.

In this solution, the height of the battery pack loaded on the electric vehicle from the battery swapping platform is greater than the height of the battery swapping equipment, so that the unloaded battery swapping equipment can drive into the battery swapping working position below the vehicle to remove the battery; the overall height of the battery swapping equipment when carrying the battery pack is smaller than the height of the bottom of the electric vehicle from the battery swapping platform, so that the battery swapping equipment carrying the battery pack can freely enter and exit the lower part of the electric vehicle, due to the height limitation above, the lifting of the electric vehicle during the battery swapping process is avoided, and the pit-digging treatment of the battery swapping station is also avoided, and the battery swapping equipment is sunk relative to the ground, accordingly, the battery swapping station corresponding to the electric vehicle battery swapping assembly in this solution has the effects of low construction cost due to no need to dig a hole for the battery swapping equipment, and the effects of reducing construction difficulty due to no need to lift the electric vehicle, and is also convenient for drainage. The battery swapping station in this solution is suitable for the situation that the vehicle body is heavy and it is difficult for the battery swapping equipment to enter and exit the bottom of the vehicle by lifting the vehicle.

Preferably, the electric vehicle comprises a vehicle beam, and the battery pack is installed below the vehicle beam by means of a locking mechanism, and the height of the bottom of the vehicle beam from the battery swapping platform is greater than the overall height of the battery swapping equipment when carrying the battery pack.

In this solution, the vehicle beam is used to install the battery pack, that is, the vehicle beam on the chassis of the electric vehicle itself is used as the carrier for installing the battery pack, so that the battery pack can be added without changing the structure of the vehicle itself. In practical application, the height of the vehicle beam from the battery swapping platform is taken as one of the parameters to develop the battery swapping equipment and battery pack, so as to ensure that the height of the bottom of the vehicle beam from the battery swapping platform is greater than the overall height of the battery swapping equipment when carrying the battery pack.

Preferably, the locking mechanism comprises a locking base, and the locking base is internally provided with a locking groove for accommodating a locking member of the battery pack, and when the locking member is located in a locking position in the locking groove, the battery pack is locked on the electric vehicle.

In this solution, a locking point is formed on the locking base, the battery pack locking member is a locking shaft, and the locking base and the locking shaft are detachable connected, when the locking shaft is located at the locking point, the battery pack is locked on the vehicle beam, and after the two are separated, the battery pack and the vehicle beam are unlocked.

Preferably, the locking base is installed on the vehicle beam, and the locking groove is located below the vehicle beam, and the overall height of the battery swapping equipment when carrying the battery pack is lower than the height of the locking groove from the battery swapping platform.

In this solution, the locking groove is the position on the locking mechanism that is directly connected with the battery pack box and used for locking the battery pack box, when installing the battery pack, the battery swapping equipment lifts the battery pack and connects it with the locking mechanism at the locking groove, when removing the battery pack, the battery swapping equipment lifts the locking mechanism to unlock the connection relationship between it and the battery pack in the locking groove, and the battery pack is seated on the battery swapping equipment, during the whole battery swapping process, because the locking groove is located below the vehicle beam, it is not easy to interfere between the battery pack and the vehicle beam, as long as the movement of the battery pack box does not collide with the vehicle beam, and it is not necessary to involve too many movement paths for the battery pack box to avoid the vehicle beam. The battery swapping equipment can avoid the vehicle beam and the locking mechanism only by moving the battery pack downward for a short distance, so as to enter and exit the bottom of the vehicle beam in the horizontal direction, and sufficient space is reserved for the battery swapping equipment to carry the battery in and out of the vehicle beam, so as to prevent the components on the vehicle from interfering with the battery swapping equipment entering and leaving the bottom of the vehicle. In other solutions, as an alternative, the locking groove of the locking mechanism is set on the side of the vehicle beam, that is, the locking groove is higher than the lower surface of the vehicle beam at the accommodation space of the battery pack box, correspondingly, in the vertical direction, the vehicle beam and the battery pack box partially overlap, this solution is beneficial to increase the distance of the lower surface of the battery pack box from the bearing plane for carrying the battery swapping equipment, and reserve more space for the battery swapping equipment to improve the safety of the system.

Preferably, the height of the lowest position of the locking base from the surface of the battery swapping platform is greater than the overall height of the battery swapping equipment when carrying the battery pack.

In this solution, the battery swapping equipment carrying the battery pack can freely enter and exit the lower part of the electric vehicle.

Preferably, the battery pack comprises a lower box and an upper cover, and the locking member is a locking shaft.

In this solution, the upper cover is closed on the lower box to form a space for accommodating the battery pack box body, the locking shaft is installed on the upper cover, and used for matching and connecting with the locking groove.

Preferably, the locking shaft is arranged below the surface of the upper cover, and a distance of the locking shaft from a highest position of the upper cover is h1; and a distance between the locking shaft and a bottom of the vehicle beam is h2, h1 is smaller than h2.

In this solution, the upper end of the battery pack box is provided with a connecting groove, and a locking shaft is arranged in the connecting groove, after the battery pack box is installed on the vehicle beam, the locking point is inserted into the connecting groove, and the highest position of the upper cover is lower than the vehicle beam. By setting the height, the interference between the battery pack box and the vehicle beam is avoided when the locking shaft enters the locking groove of the locking mechanism, that is, when the locking shaft enters the locking mechanism in the vertical direction, the movement of the battery pack box will not collide with the vehicle beam.

Preferably, the locking shaft is arranged higher than the surface of the upper cover, and the distance of the locking shaft to the surface of the upper cover is h3; when the battery pack is carried by the battery swapping equipment, the sum of the height of the upper cover from the battery swapping platform and h3 is smaller than the height of the bottom of the locking base from the battery swapping platform.

In this solution, the battery swapping equipment carrying the battery pack box can freely enter and exit the bottom of the electric vehicle. When installing the battery pack, after the battery swapping equipment is aligned, lift the battery pack box to connect it with the locking mechanism. In this solution, the locking shaft is higher than the surface of the upper cover, and correspondingly, the locking point is also higher than the surface of the upper cover, which is convenient for the locking shaft to be installed or removed from the locking mechanism.

Preferably, the depth of the locking base entering into the battery pack is between 39 mm to 100 mm.

Preferably, the locking base is installed on the side wall of the vehicle beam by means of an installing bracket, and the height of the bottom of the installing bracket from the battery swapping platform is greater than the overall height of the battery swapping equipment when carrying the battery pack.

In this solution, the installing bracket is connected to the vehicle beam by means of the fastener, and the locking base is connected to the vehicle beam by means of the installing bracket, so that the existing vehicle can be transformed into an electric vehicle by adding the installing bracket without changing the structure of the existing vehicle, as long as the height of the installing bracket from the battery swapping platform is ensured to be greater than the overall height of the battery swapping equipment when carrying the battery pack, the battery swapping equipment can be guaranteed to freely enter and leave the lower part of the vehicle. The installing bracket not only has the function of connecting the battery pack and the vehicle beam, but also has the function of bearing part of the weight of the battery pack, thus reducing the influence of the battery pack on the rigidity and strength of the vehicle beam.

Preferably, the locking shaft is set higher than the surface of the upper cover, and the distance of the locking shaft from a surface of the upper cover is h3, when the battery pack is carried by the battery swapping equipment, the sum of the height between the surface of the upper cover and the battery swapping platform and h3 is smaller than the height between the bottom of the installing bracket and the battery swapping platform.

In this solution, the battery swapping equipment carrying the battery pack can freely enter and exit the bottom of the electric vehicle. When installing the battery pack, after the battery swapping equipment is aligned, lift the battery pack to connect it with the locking mechanism. In this solution, the locking shaft is higher than the surface of the upper cover, and correspondingly, the locking point is also higher than the surface of the upper cover.

Preferably, the battery swapping platform is provided with a track for the running of the battery swapping equipment, and the sum of the height of the track protruding from the battery swapping platform and the height of the battery swapping equipment when it is unloaded is smaller than the height of the bottom of the battery pack loaded on the electric vehicle from the battery swapping platform.

In this solution, the battery swapping equipment is a railed shuttle, the battery swapping equipment loaded with battery pack can freely enter and exit the bottom of the electric vehicle.

Preferably, the sum of the height of the track protruding from the battery swapping platform and the overall height of the battery swapping equipment when carrying the battery pack is smaller than the height of the bottom of the vehicle beam of the electric vehicle from the battery swapping platform.

Preferably, the battery swapping equipment is at least partially lower than the upper surface of the track.

In this solution, the upper end of the track goes deep into the battery swapping equipment and guides it. A gap is maintained between the battery swapping equipment and the battery swapping platform by means of the track, and the height of the gap is greater than 20 mm, so as to ensure the safe and smooth operation of the battery swapping equipment.

Preferably, the battery swapping equipment is installed on the battery swapping working position of the battery swapping platform, and when an electric vehicle drives into the battery swapping platform in the first direction, the width of the battery swapping equipment in the second direction perpendicular to the first direction is smaller than the distance between the left and right wheels of the electric vehicle.

In this solution, electric vehicle can drive in and out of the battery swapping platform without obstacles.

Preferably, the battery swapping equipment comprises a installing platform and an elastic mechanism arranged on the installing platform, and the elastic mechanism is used for elastically supporting the battery pack; when the battery pack is carried on the elastic mechanism, the compression deformation of the elastic mechanism is s, and a sum of the height of the battery swapping equipment itself and the height of the battery pack itself is smaller than a sum of a height of a bottom of the vehicle beam of the electric vehicle from the battery swapping platform and s.

In this solution, after the battery pack is placed on the installation platform, the elastic mechanism can buffer the impact between the battery pack and the installation platform, thus reducing the hard collision and noise generated between them. In this solution, the deformation of the elastic mechanism on the vertical square is reserved, when the battery pack falls on the installation platform in the process of removing the battery pack, the two will float up and down or even tilt relative to the main part of the battery swapping equipment, this solution has reserved the displacement caused by floating and tilting in the height direction, which ensures that the floating and tilting of the battery pack will not interfere with other components, thus improving the safety of the system.

Preferably, the lifting height of the battery swapping equipment ranges from 120 mm to 200 mm.

Preferably, the battery swapping equipment lifts the battery pack by means of a cam lifting mechanism.

Preferably, the floor of the battery swapping station is formed as the battery swapping platform.

Preferably, when fully loaded, the distance between the vehicle beam of the electric vehicle and the ground is between 460 mm to 580 mm;
the difference between the height of the battery pack loaded on the electric vehicle from the ground and the height of the battery swapping equipment is between 30 mm to 80 mm.

Preferably, the difference between the overall height of the battery swapping equipment when carrying the battery pack and the height of the bottom of the electric vehicle from the battery swapping platform is between 10 mm to 150 mm.

On the basis of common sense in the field, the above-mentioned preferred conditions can be arbitrarily combined to obtain the preferred embodiments of the present invention.

The positive improved effects of the present disclosure are that:

In the present invention, the electric vehicle battery swapping assembly can swap battery for the electric vehicle on the ground, thus avoiding lifting the electric vehicle in the process of battery swapping, avoiding the digging treatment of the battery swapping station, and making the battery swapping equipment sink relative to the ground, correspondingly, the battery swapping station corresponding to the electric vehicle battery swapping assembly has the effects of low construction cost due to no need to dig holes for the battery swapping equipment, and reducing the construction difficulty due to no need to lift the electric vehicle.

The invention does not need to lift the vehicle or dig a hole on the ground to set up the battery swapping equipment, considering the high weight and load of the electric truck itself, the invention is especially suitable for electric truck, which improves the safety of the battery swapping station and can improve the battery swapping efficiency.

### BRIEF DESCRIPTION OF THE DRAWINGS

FIG. 1 is a schematic diagram of a battery pack locked on an electric vehicle. FIG. 2 is a schematic diagram of the battery swapping equipment under the electric vehicle. FIG. 3 is a schematic diagram of the connection structure between the vehicle beam and the installing bracket. FIG. 4 is a schematic diagram of a locking mechanism. FIG. 5 is a schematic diagram of an unlocking linkage mechanism. FIG. 6 is a schematic diagram of an embodiment in which the locking shaft is lower than the surface of the battery pack. FIG. 7 is a schematic diagram of an embodiment in which the locking shaft is higher than the surface of the battery pack. FIG. 8 is a schematic diagram when the battery pack is locked on the electric vehicle and the battery swapping equipment is located below the battery pack. FIG. 9 is a partial structural diagram of an electric vehicle loaded with a battery pack.

### DESCRIPTION OF REFERENCE NUMERALS

Battery swapping equipment 1; battery pack box 2; vehicle beam 3; installing bracket 4; locking mechanism 5; locking base 51; locking shaft 6; unlocking linkage mechanism 7.

### DETAILED DESCRIPTION OF THE PREFERRED EMBODIMENT

The present invention will be further illustrated by way of embodiments, but it is not limited to the following embodiments. Before further explaining the present invention, briefly explain FIG. 8, which is a schematic diagram when the battery pack is locked on the electric vehicle and the battery swapping equipment is located below the battery pack, in order to more clearly embody the solution of the present invention, the height of the battery pack box 2 is illustrated in ‘a’, the depth of the locking base 51 into the battery pack box 2 is illustrated in ‘b’, the height of the battery swapping equipment 1 to the bearing plane for carrying the battery swapping equipment is illustrated in ‘c’, the height of the battery pack (or battery pack box 2) installed on the electric vehicle to the bearing plane for carrying the battery swapping equipment is illustrated in ‘d’, and the height of the installing bracket to the bearing plane for carrying the battery swapping equipment is illustrated in ‘e’. Although the following text refers to the characters “a, b, c, d, e”, the person skilled in the art should be able to correspond to the above description based on the content of the following text.

### Embodiment 1

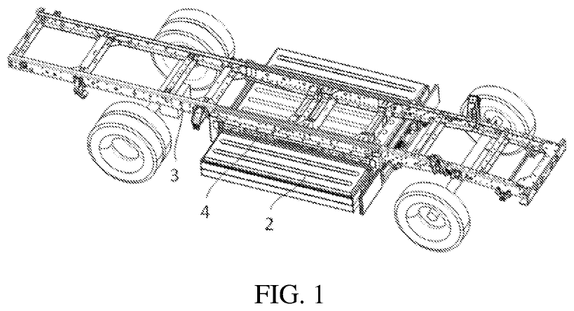

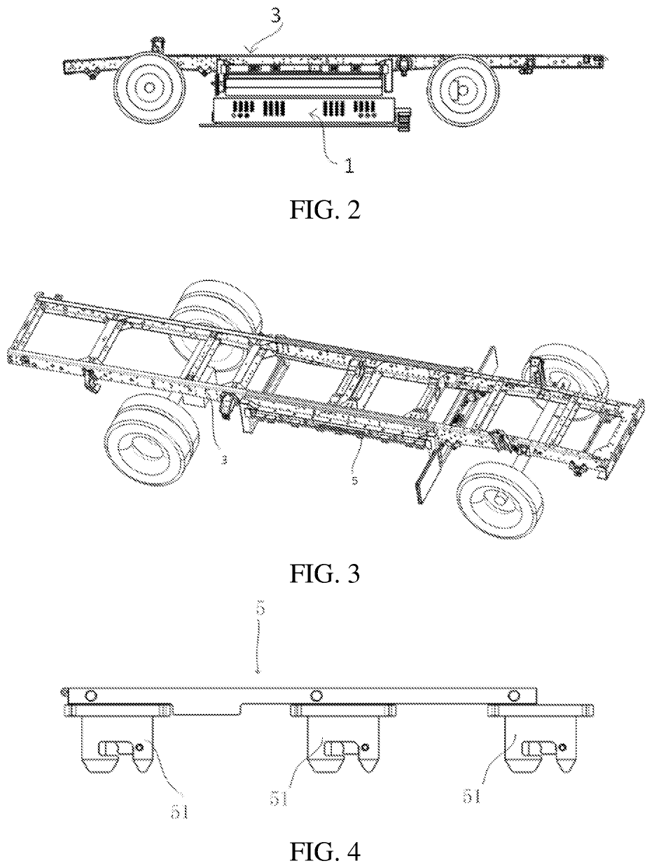

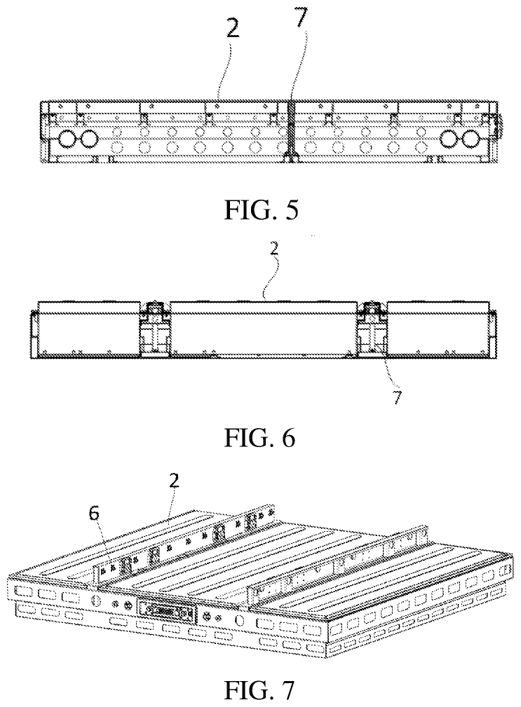

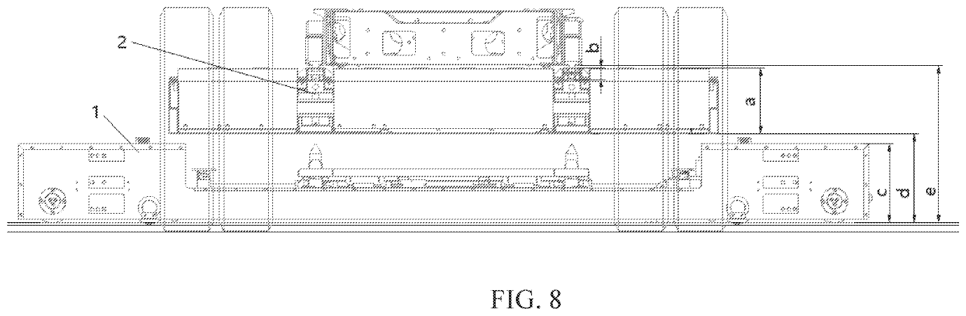

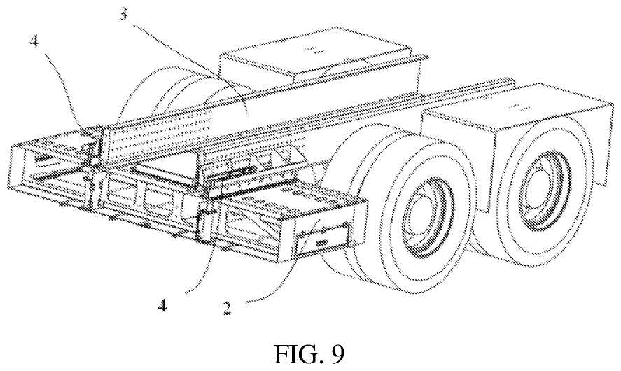

Referring to FIGS. 1-9 for understanding, an embodiment of the present invention provides an electric vehicle battery swapping assembly, which is used in a battery swapping station for swapping a battery pack for an electric vehicle, the battery pack comprises a battery pack box 2 and a battery pack body, and the battery pack body is built in the battery pack box 2.

An electric vehicle battery swapping assembly comprises a battery swapping equipment 1 and a battery pack box 2, wherein both the battery swapping equipment 1 and the battery pack box 2 are arranged at the bottom of the electric vehicle, and the battery pack box 2 is removed or installed from the bottom of the electric vehicle by means of the battery swapping equipment 1, and the height of the electric vehicle is unchanged during the removal or installation process, and the bearing plane for carrying the battery swapping equipment 1 and the bearing plane for carrying the electric vehicle are in the same plane.

Wherein, the battery pack box 2 is used for building in battery pack body to provide power for the electric vehicle. The battery swapping equipment 1 is arranged in the battery swapping station. In the process of battery swapping, the unloaded battery swapping equipment 1 drives into the lower part of the electric vehicle, removes the battery pack box 2 with built-in a insufficiently charged battery pack body on the electric vehicle, and transports it back to the station for storage, then, the power battery swapping equipment 1 transports the battery pack box 2 with built-in a fully charged battery pack body 2 to the lower part of the electric vehicle and installs it on the electric vehicle. In the process of battery swapping, the bearing plane for carrying battery swapping equipment 1 for the operation of battery swapping equipment and the bearing plane for carrying vehicle for the operation of electric vehicles are in the same plane, and the height of electric vehicles is unchanged, so that the unloaded battery swapping equipment 1 can freely enter and exit the lower part of electric vehicles equipped with battery pack box 2, and the fully loaded battery swapping equipment 1 can freely enter and exit the lower part of electric vehicles without battery pack box 2, in other words, the electric vehicle battery swapping equipment 1 in this embodiment can be set on the ground, the lifting of the electric vehicle in the process of battery swapping is avoided, and the pit-digging treatment of the battery swapping station is also avoided, and the battery swapping equipment 1 is set to sink relative to the ground, accordingly, the battery swapping station corresponding to the electric vehicle battery swapping assembly in this embodiment has the effect of low construction cost due to no need to dig a pit for the battery swapping assembly, and the effect of reducing construction difficulty due to no need to lift the electric vehicle.

From the above, it can be seen that the battery swapping station corresponding to the electric vehicle battery swapping assembly in this embodiment does not need to lift the vehicle or dig a hole on the ground to set up battery swapping equipment 1, considering the high weight and load of the electric truck itself, the above effect is particularly important for the electric truck, the electric vehicle battery swapping assembly realizes the battery swapping function of the electric truck on the ground, improves the safety of the battery swapping station, improves the battery swapping efficiency.

In this embodiment, by setting the height relationships between the bottom of the electric vehicle, the battery swapping equipment 1 and the battery pack box 2, the effect of swapping the battery of the electric vehicle can be achieved without lifting the electric vehicle or digging a hole. The heights of the bottom of the electric vehicle and the battery pack box 2 are set to satisfy the following two conditions:
Condition one: When the battery swapping equipment 1 removes the battery pack box 2, a height of the bottom of the battery pack box 2 from the bearing plane for carrying the battery swapping equipment 1 is greater than a height of the battery swapping equipment 1 when it is unloaded; when an electric vehicle is loaded with a battery pack, the center of gravity of the whole vehicle sinks, when the first condition is met, no matter whether the electric vehicle is loaded with a battery pack or not, the unloaded battery swapping equipment 1 can freely enter and exit the bottom of the electric vehicle.
Condition two: When the battery swapping equipment 1 installs the battery pack box 2, a height of the bottom of the electric vehicle from the bearing plane for carrying the battery swapping equipment 1 is greater than an overall height of the battery swapping equipment 1 when carrying the battery pack box 2; when the battery pack box 2 is carried by the battery swapping equipment 1, the overall height of the two is higher than that of a single battery swapping equipment 1, when the second condition is met, the battery swapping equipment carrying the battery pack box 2 can freely enter and exit the bottom of the electric vehicle regardless of whether the battery pack box 2 is carried on the electric vehicle.

In this embodiment, the electric vehicle battery swapping assembly meets both conditions one and two, and realizes the swapping operation under the condition that the bearing plane for carrying the battery swapping equipment 1 and the bearing plane for carrying the electric vehicle are on the same plane and the electric vehicle is not lifted. Accordingly, the developers developed these products, such as the battery swapping equipment 1, the battery pack box 2, and the connection structure between the battery pack box 2 and the electric vehicle, based on conditions one and two.

In this embodiment, the electric vehicle comprises a vehicle beam 3, and the battery pack box 2 is detachable installed on the vehicle beam 3 by means of a locking mechanism 5, and the height of the bottom of the vehicle beam 3 from the 1 bearing plane for carrying the battery swapping equipment 1 is greater than the overall height of the battery swapping equipment 1 when carrying the battery pack box 2. The battery pack box 2 is installed by the vehicle beam 3, vehicle beam 3 can be realized by the prior art, so that the battery pack can be added without changing the structure of the vehicle itself. In practical application, the height of the vehicle beam 3 from the ground is taken as one of the parameters to develop the battery swapping equipment 1 and battery pack, so as to ensure that the height of the bottom of the vehicle beam 3 from the bearing plane for carrying the battery swapping equipment 1 is greater than the overall height of the battery swapping equipment 1 when carrying the battery pack box 2.

In this embodiment, the electric vehicle is an electric truck, and an accommodating space of battery pack box 2 is arranged between two sets of wheels of the electric truck along the driving direction, and the height of the vehicle beam 3 at accommodating space of the battery pack box 2 is greater than the overall height of the battery swapping equipment 1 when carrying the battery pack box 2.

The space between the two sets of wheels in the driving direction of the electric truck is used to set the battery pack box 2, which is convenient to control the center of gravity of the whole vehicle in the middle of the electric truck and avoid the risk of top-heavy or top-heavy; for the existing electric truck, the space between the two sets of wheels in the driving direction is larger in the length and width direction compared with other positions, which allows the battery pack box 2 to occupy a larger space, thus allowing the battery pack with higher capacitance to be arranged; reasonable use of the space between the two sets of wheels in the driving direction also improves the compactness of the electric truck structure. The height of the vehicle beam 3 at the accommodation space of the battery pack box 2 is greater than the overall height of the battery swapping equipment 1 when carrying the battery pack box 2, so that the battery swapping equipment 1 carrying the battery pack box 2 can freely enter and leave the lower part of the vehicle beam 3 to install the battery pack box 2 on the vehicle beam 3 from below.

In this embodiment, the battery pack box 2 is arranged below the vehicle beam 3, so that on the one hand, the center of gravity of the battery pack box 2 is lowered, and the installation safety of the battery pack box 2 on the vehicle is improved; on the other hand, the space below the vehicle beam 3 is used to install the battery pack box 2, which not only ensures the integrity of the battery pack box 2, but also does not need to change the structure of the vehicle beam 3 itself to carry a large-size battery pack box 2, when removing the battery pack box 2, unload battery swapping equipment 1 runs from the side of the electric truck to the lower part of the vehicle beam 3, and the battery swapping equipment 1 lifts the switch of the locking mechanism 5 to unlock it from the battery pack box 2, and the battery pack is seated on the battery swapping equipment 1, when installing the battery pack box 2, the fully loaded battery swapping equipment 1 runs from the side of the electric truck to the lower part of the vehicle beam 3 to lift the battery pack box 2 and connect it with the locking mechanism 5, during the whole removal and installation process, the movement of the battery pack box 2 is not interfered by the vehicle beam 3 and other components of the electric truck, making removal and installation convenient and improving the efficiency of power exchange. In other embodiments, as an alternative, the battery pack box 2 is at least partially overlapped with the vehicle beam 3 in the vertical direction, that is, the lower side of the vehicle beam 3 is partially embedded in the upper end of the battery pack box 2, so that the height of the battery pack box 2 from the bearing plane for carrying the battery swapping equipment 1 is higher, and a larger space is reserved for the unloaded battery swapping equipment 1, which is convenient for the unloaded battery swapping equipment 1 to freely enter and exit the space below the vehicle.

In this embodiment, the locking point of the locking mechanism 5 is set below the vehicle beam 3, the locking point is the position on the locking mechanism 5 that directly connects with the battery pack box 2 and is used to lock the battery pack box 2, when installing the battery pack box 2, the battery swapping equipment 1 lifts the battery pack box 2 and connects it with the locking mechanism 5 at the locking point, when removing the battery pack box 2, the battery swapping equipment 1 lifts the locking mechanism 5 to unlock the connection relationship of the locking mechanism 5 with the battery pack box 2 at the locking point, and the battery pack is seated on the battery swapping equipment 1, during the whole battery swapping process, because the locking point is located below the vehicle beam 3, interference between the battery pack box 2 and the vehicle beam 3 is not easy to occur, so that the vehicle beam 3 is not greatly changed, and the large-size battery pack box 2 can be integrally installed on the vehicle beam 3. The battery swapping equipment 1 only needs to move the battery pack box 2 downward for a short distance to avoid the vehicle beam 3 and the locking mechanism 5, so as to enter and exit the bottom of the vehicle beam 3 in the horizontal direction, and sufficient space is reserved for the battery swapping equipment 1 to enter and exit the bottom of the vehicle beam 3, so as to prevent the components on the vehicle from interfering with the entry and exit of the battery swapping equipment 1. In other embodiments, as an alternative, the locking point of the locking mechanism 5 is set on the side of the vehicle beam 3, that is, the locking point is higher than the lower surface of the vehicle beam 3 at the accommodation space of the battery pack box 2, correspondingly, in the vertical direction, the vehicle beam 3 and the battery pack box 2 partially overlap, this solution is beneficial to increase the distance from the lower surface of the battery pack box 2 to the bearing plane for carrying the battery swapping equipment 1, and reserve more space for the battery swapping equipment 1 to improve the safety of the system.

In this embodiment, the battery pack box 2 comprises a lower box and an upper cover, which covers the lower box to form a space for accommodating the battery pack body, the battery pack box 2 is provided with a locking shaft 6, which is installed on the lower box or the upper cover, and is detachable connected with the locking mechanism 5, and a locking point is formed at the connection between the locking shaft 6 and the locking mechanism 5.

In this embodiment, the locking shaft 6 is arranged below the surface of the upper cover, and the distance of the locking shaft 6 from the highest position of the upper cover is h1, and the distance between the locking point and the bottom of the vehicle beam 3 is h2, and h1 is smaller than h2, in other words, the upper end of the battery pack box 2 is provided with a connecting groove in which the locking shaft 6 is arranged, after the battery pack box 2 is installed on the vehicle beam 3, the locking point is inserted into the connecting groove, and the highest position of the upper cover is lower than the vehicle beam 3. In this embodiment, the battery pack box 2 is located below the vehicle beam 3, so it is not easy to interfere between the battery pack box 2 and the vehicle beam 3, as long as the movement of the battery pack box 2 is ensured not to collide with the vehicle beam 3, and it is unnecessary to involve too many movement paths for the battery pack box 2 to avoid the vehicle beam 3.

In another embodiment, the locking shaft 6 is set higher than the surface of the upper cover, and the distance between the locking shaft 6 and the surface of the upper cover is h3, when the battery swapping equipment 1 carries the battery pack, the sum of the height of the upper cover from the battery swapping platform and h3 is smaller than the height of the locking point from the battery swapping platform, so that the battery swapping equipment 1 carrying the battery pack box 2 can freely enter and exit the bottom of the electric vehicle. When installing the battery pack, after the battery swapping equipment 1 is aligned, lift the battery pack box 2 to connect it with the locking mechanism 5. In this embodiment, the locking shaft 6 is higher than the surface of the upper cover, and correspondingly, the locking point is also higher than the surface of the upper cover.

In this embodiment, the locking mechanism 5 comprises a locking base 51, and the depth of the locking base 51 entering the battery pack box 2 is between 39 mm to 100 mm. The locking point is formed on the locking base 51, and the locking base 51 is detachable connected with the locking shaft 6, when the locking base 51 and the locking shaft 6 are connected, the battery pack box 2 is locked on the vehicle beam 3, and when the locking base 51 and the locking shaft 6 are separated, the battery pack box 2 and the vehicle beam 3 are unlocked.

In this embodiment, the locking base 51 is installed on the side wall of the vehicle beam 3 by means of a installing bracket 4, and the height of the bottom of the installing bracket 4 from the bearing plane for carrying the battery swapping equipment is greater than the overall height of the battery swapping equipment 1 when carrying the battery pack box 2. The installing bracket 4 is connected to the vehicle beam 3 by means of the fastener, and the locking base 51 is connected to the vehicle beam 3 by means of the installing bracket 4, so that the existing vehicle can be transformed into an electric vehicle by adding the installing bracket 4 without changing the structure of the existing vehicle, as long as the height of the installing bracket 4 from the bearing plane for carrying the battery swapping equipment 1 is ensured to be greater than overall height of the battery swapping equipment 1 when carrying the battery pack, the battery swapping equipment can be guaranteed to freely enter and leave the lower part of the vehicle. The installing bracket 4 not only has the function of connecting the battery pack box 2 and the vehicle beam 3, but also has the function of bearing part of the weight of the battery pack, thus reducing the influence of the battery pack on the rigidity and strength of the vehicle beam 3.

In this embodiment, the locking shaft 6 is arranged below a surface of the upper cover, and a section of the battery pack box 2 is shown in FIG. 6 to show that the locking shaft 6 is lower than the surface of the upper cover, so it is not marked in FIG. 6 considering that the locking shaft 6 is relatively small. In another embodiment, as shown in FIG. 7, the locking shaft 6 is set higher than the surface of the upper cover, and a distance of the locking shaft 6 from the surface of the upper cover is h3, when the battery swapping equipment 1 carries the battery pack, the sum of the height of the surface of the upper cover from the battery swapping platform and h3 is smaller than the height of the bottom of the installing bracket 4 from the bearing plane for carrying the battery swapping equipment, so that the battery swapping equipment 1 carrying the battery pack box 2 can freely enter and exit the bottom of the electric vehicle. When installing the battery pack, after the battery swapping equipment 1 is aligned, lift the battery pack box 2 to connect it with the locking mechanism 5. In this embodiment, the locking shaft 6 is higher than the surface of the upper cover, and correspondingly, the locking point is also higher than the surface of the upper cover.

In this embodiment, as shown in FIG. 5, the battery pack box 2 further comprises an unlocking linkage mechanism 7, and the unlocking linkage mechanism 7 penetrates through the battery pack box 2 in the vertical direction.

The unlocking linkage equipment is arranged on the battery pack box 2 for unlocking the battery pack and the locking mechanism 5 on the vehicle; the unlocking linkage equipment comprises an input end and an output end, and the input end of the unlocking linkage mechanism in the initial state is driven by external equipment to act on the locking mechanism 5 to unlock.

The unlocking process is as follows: the battery swapping equipment in the battery swapping station loads the input end in the preset direction, and the input end pushes the output end to move to unlock the locking mechanism 5. After the acting force of the battery swapping equipment 1 on the input end disappears, the input end and the output end are reset to the initial state under the action of elastic force.

Since the input end and the output end are elastically connected in the preset direction, when the output end contacts the locking mechanism 5, the elastic force between the input end and the output end buffers the collision force between the output end and the locking mechanism 5, thus avoiding hard impact on the locking mechanism 5, thus contributing to the durability of the output end and the locking mechanism 5.

In this embodiment, the preset direction is up and down, that is, the input end and output are set up and down, where the input end is located below and the output end is located above, and the battery swapping equipment 1 pushes the input end to move from below the battery pack.

In this embodiment, the input end and output end are provided on different members, while in other embodiments, the input end and output end can be located on the same member.

### Embodiment 2

Referring to FIGS. 1-9 to understand this embodiment. This embodiment provides a battery swapping station, which comprises a battery swapping platform and battery swapping equipment 1. The above-mentioned bearing plane for carrying the battery swapping equipment and the bearing plane of the vehicle are formed on the battery swapping platform, the battery swapping platform is used for parking electric vehicle to removal and installation the battery pack; and the bearing plane for carrying the battery swapping equipment 1 for the battery swapping equipment 1 driving and the bearing plane for electric vehicle are formed on the battery swapping platform. The battery swapping equipment 1 is used to remove and install the battery pack of the electric vehicle on the battery swapping platform; among them, the height of the bottom of the battery pack loaded on the electric vehicle from the battery swapping platform is greater than the height of the battery swapping equipment 1 when it is unloaded; overall height of the battery swapping equipment 1 when carrying the battery pack is smaller than the height of the bottom of the electric vehicle from the battery swapping platform.

In this embodiment, the removing process begins, and the unloaded battery swapping equipment 1 directly drives into the battery swapping working position by means of the plane of the battery swapping platform to take down the battery pack of the vehicle body; and after swapping the new battery, the battery swapping equipment 1 carrying the new battery still directly drives into the battery swapping working position by means of the plane of the battery swapping platform to load the new battery to the bottom of the vehicle body.

The height of the battery pack loaded on the electric vehicle from the battery swapping platform is greater than the height of the battery swapping equipment 1, so that the unloaded battery swapping equipment I can drive into the battery swapping working position below the vehicle to remove the battery; overall height of the battery swapping equipment 1 when carrying the battery pack is smaller than the height of the bottom of the electric vehicle from the battery swapping platform, so that the battery swapping equipment 1 carrying the battery pack can freely enter and exit the lower part of the electric vehicle, due to the height limitation above, the lifting of the electric vehicle during the battery swapping process is avoided, and the pit-digging treatment of the battery swapping station is also avoided, and the battery swapping equipment 1 is sunk relative to the ground, accordingly, the battery swapping station corresponding to the electric vehicle battery swapping assembly in this embodiment has the effects of low construction cost due to no need to dig a hole for the battery swapping equipment 1, and the effect of reducing construction difficulty due to no need to lift the electric vehicle. The battery swapping station in this embodiment is suitable for the situation that the vehicle body is heavy and it is difficult for the battery swapping equipment 1 to enter and exit the bottom of the vehicle by lifting the vehicle.

In this embodiment, the difference between the height of the battery pack loaded on the electric vehicle from the ground and the height of the battery swapping equipment 1 is between 30 mm to 80 mm.

The difference between overall height of the battery swapping equipment 1 when carrying the battery and the height of the bottom of the electric vehicle from the battery swapping platform is between 10 mm to 150 mm.

In this embodiment, the electric vehicle comprises a vehicle beam 3, and the battery pack is detachable installed on the vehicle beam 3 by means of the locking mechanism, and the height of the bottom of the vehicle beam 3 from the battery swapping platform is greater than overall height of the battery swapping equipment 1 when carrying the battery pack.

The vehicle beam 3 is used to install the battery pack box 2, that is, the vehicle beam 3 on the chassis of the electric vehicle itself is used as the carrier for installing the battery pack box, so that the battery pack can be added without changing the structure of the vehicle itself. In practical application, the height of the vehicle beam 3 from the bearing plane for carrying the battery swapping equipment 1 is taken as one of the parameters to develop the battery swapping equipment 1 and the battery pack, so as to ensure that the height of the bottom of the vehicle beam from the battery swapping platform is greater than overall height of the battery swapping equipment 1 when carrying the battery pack. Vehicle beam 3 battery swapping equipment 1

As shown in FIG. 4, in this embodiment, the locking mechanism 5 comprises a locking base 51, and a locking groove for accommodating the locking member of the battery pack is arranged in the locking base 51, and when the locking member is located in the locking position in the locking groove, the battery pack is locked on the electric vehicle. The locking point is formed on the locking base 51, the locking member of the battery pack is a locking shaft 6, and the locking base 51 and the locking shaft 6 are detachable connected, when the locking shaft 6 is located at the locking point, the battery pack is locked on the vehicle beam 3, and after the two are separated, the battery pack and the vehicle beam 3 are unlocked.

In this embodiment, the locking base 51 is installed on the vehicle beam 3, and the locking groove is located below the vehicle beam 3, and the overall height of the battery swapping equipment 1 when carrying the battery pack is lower than the height of the locking groove from the battery swapping platform. The locking groove is the position on the locking mechanism 5 that is directly connected with the battery pack box 2 and used for locking the battery pack, when installing the battery pack, the battery swapping equipment 1 lifts the battery pack and connects it with the locking mechanism 5 at the locking groove, when removing the battery pack, the battery swapping equipment 1 lifts the locking mechanism 5 to unlock the connection relationship between it and the battery pack in the locking groove, and the battery pack is seated on the battery swapping equipment 1, during the whole battery swapping process, because the locking groove is located below the vehicle beam 3, it is not easy to interfere between the battery pack and the vehicle beam 3, as long as the movement of the battery pack box 2 does not collide with the vehicle beam 3, and it is not necessary to involve too many movement paths for the battery pack to avoid the vehicle beam 3. The battery swapping equipment 1 can avoid the vehicle beam and the locking mechanism 5 only by moving the battery pack downward for a short distance, so as to enter and exit the bottom of the vehicle beam 3 in the horizontal direction, and sufficient space is reserved for the battery swapping equipment 1 to carry the battery enter and exit the vehicle beam 3, so as to prevent the components on the vehicle from interfering with the battery swapping equipment 1 entering and leaving the bottom of the vehicle. In other embodiments, as an alternative, the locking groove of the locking mechanism 5 is set on the side of the vehicle beam 3, that is, the locking groove is higher than the lower surface of the vehicle beam 3 at the accommodation space of the battery pack box 2, correspondingly, in the vertical direction, the vehicle beam 3 and the battery pack box 2 partially overlap, this solution is beneficial to increase the distance from the lower surface of the battery pack box 2 to the bearing plane for carrying the battery swapping equipment 1, and reserve more space for the battery swapping equipment 1 to improve the safety of the system.

In this embodiment, the height of the lowest position of the locking base 51 from the surface of the battery swapping platform is greater than the overall height of the battery swapping equipment 1 when carrying the battery pack, so that the battery swapping equipment 1 carrying the battery pack can freely enter and exit the lower part of the electric vehicle.

In this embodiment, the battery pack comprises a lower box and an upper cover, the upper cover is closed on the lower box to form a space for accommodating the battery pack body, and the locking member is a locking shaft 6, the locking shaft 6 is installed on the upper cover or the lower box, and used for matching and connecting with the locking groove.

In this embodiment, the locking shaft 6 is arranged below the surface of the upper cover, and the distance of the locking shaft 6 from the highest position of the upper cover is h1, and the distance between the locking groove and the bottom of the vehicle beam 3 is h2, and h1 is smaller than h2, in other words, the upper end of the battery pack box 2 is provided with a connecting groove in which the locking shaft 6 is arranged, after the battery pack box 2 is installed on the vehicle beam 3, the locking point is inserted into connecting groove, and the highest position of the upper cover is lower than the vehicle beam 3. In this embodiment, the battery pack box 2 is located below the vehicle beam 3, by setting the height above, the interference between the battery pack box 2 and the vehicle beam 3 is avoided when the locking shaft 6 enters the locking groove of the locking mechanism 5, that is, when the locking shaft 6 enters the locking mechanism 5 in the vertical direction, the movement of the battery pack box will not collide with the vehicle beam.

In another embodiment, the locking shaft 6 is set higher than the surface of the upper cover, and the distance of the locking shaft 6 from the surface of the upper cover is h3, when the battery pack is carried by the battery swapping equipment 1, the sum of the height of the upper cover from the battery swapping platform and h3 is smaller than the height of the bottom of the locking base 51 from the battery swapping platform, so that the battery swapping equipment 1 carrying the battery pack box 2 can freely enter and exit the bottom of the electric vehicle. When installing the battery pack, after the battery swapping equipment 1 is aligned, lift the battery pack box 2 to connect it with the locking mechanism 5. In this embodiment, the locking shaft 6 is higher than the surface of the upper cover, and correspondingly, the locking point is also higher than the surface of the upper cover, which is convenient for the locking shaft 6 to be installed or removed from the locking mechanism 5.

In this embodiment, the depth of the locking base 51 into the battery pack is between 39 mm to 100 mm.

In this embodiment, the locking base 51 is installed on the side wall of the vehicle beam 3 by means of an installing bracket 4, and the height of the bottom of the installing bracket 4 from the battery swapping platform is greater than the overall height of the battery swapping equipment 1 when carrying the battery pack. The installing bracket 4 is connected to the vehicle beam 3 by means of the fastener, and the locking base 51 is connected to the vehicle beam 3 by means of the installing bracket 4, so that the existing vehicle can be transformed into an electric vehicle by adding the installing bracket 4 without changing the structure of the existing vehicle, as long as the height of the installing bracket 4 from the battery swapping platform is ensured to be greater than the overall height of the battery swapping equipment 1 when carrying the battery pack, the battery swapping equipment 1 can be guaranteed to freely enter and leave the lower part of the vehicle. The installing bracket 4 not only has the function of connecting the battery pack and the vehicle beam 3, but also has the function of bearing part of the weight of the battery pack, thus reducing the influence of the battery pack on the rigidity and strength of the vehicle beam 3.

In this embodiment, the locking shaft 6 is set lower than the surface of the upper cover, while in another embodiment, the locking shaft 6 is set higher than the surface of the upper cover, and the distance between the locking shaft 6 and the surface of the upper cover is h3, when the battery pack is carried by the battery swapping equipment 1, the sum of the height of the surface of the upper cover from the battery swapping platform and h3 is smaller than the height of the bottom of installing bracket 4 from the battery swapping platform, so that the battery swapping equipment 1 carrying the battery pack can freely enter and exit the bottom of the electric vehicle. When installing the battery pack, after the battery swapping equipment is aligned, lift the battery pack to connect it with the locking mechanism 5. In this embodiment, the locking shaft 6 is higher than the surface of the upper cover, and correspondingly, the locking point is also higher than the surface of the upper cover.

In this embodiment, the battery swapping equipment 1 is a railed shuttle, the battery swapping platform is provided with a track for the running of the battery swapping equipment 1, and the sum of the height of the track protruding from the battery swapping platform and the height of the battery swapping equipment 1 when it is unloaded is smaller than the height of the bottom of the battery pack loaded on the electric vehicle from the battery swapping platform, so that the battery swapping equipment 1 loaded with the battery pack can freely enter and exit the bottom of the electric vehicle.

In this embodiment, the sum of the height of the track protruding from the battery swapping platform and the overall height of the battery swapping equipment 1 when carrying the battery pack is smaller than the height of the bottom of the vehicle beam 3 of the electric vehicle from the battery swapping platform, so that the battery swapping equipment 1 loaded with the battery pack can freely enter and exit the bottom of the electric vehicle.

In this embodiment, the battery swapping equipment 1 is at least partially lower than the upper surface of the track, in other words, the upper end of the track goes deep into the battery swapping equipment 1 and guides it. A gap is maintained between the battery swapping equipment 1 and the battery swapping platform by means of the track, and the height of the gap is greater than 20 mm, so as to ensure the safe and smooth operation of the battery swapping equipment 1.

In this embodiment, the battery swapping equipment 1 adopts track system, but in another embodiment, the battery swapping equipment 1 adopts trackless system, which is fixed, the battery swapping equipment 1 is installed on the battery swapping working position of the battery swapping platform, and when an electric vehicle drives into the battery swapping platform in the first direction, the width of the battery swapping equipment 1 in the second direction perpendicular to the first direction is smaller than the distance between the left and right wheels of the electric vehicle, so that the electric vehicle can drive into and out of the battery swapping platform without obstacles.

In this embodiment, the battery swapping equipment 1 comprises a installing platform and an elastic mechanism arranged on the installing platform, and the elastic mechanism is used for elastically supporting the battery pack; when the battery pack is carried on the elastic mechanism, the compression deformation of the elastic mechanism is s, and a sum of the height of the battery swapping equipment 1 itself and the height of the battery pack itself is smaller than the sum of the height of the bottom of the vehicle beam of the electric vehicle 3 from the battery swapping platform and s. After the battery pack is placed on the installation platform, the elastic mechanism can buffer the impact between the battery pack and the installation platform, thus reducing the hard collision and noise generated between them. In this embodiment, the deformation of the elastic mechanism on the vertical direction is reserved, when the battery pack falls on the installation platform in the process of removing the battery pack, the two will float up and down or even tilt relative to the main part of the battery swapping equipment, this embodiment has reserved the displacement caused by floating and tilting in the height direction, which ensures that the floating and tilting of the battery pack will not interfere with other components, thus improving the safety of the system.

The lifting height of the battery swapping equipment 1 ranges from 120 mm to 200 mm. In this embodiment, the height of the battery swapping equipment 1 is 120 mm. In this embodiment, the battery swapping equipment 1 lifts the battery pack by means of a cam lifting mechanism. In this embodiment, the floor of the battery swapping station is formed as the battery swapping platform. In this embodiment, when fully loaded, the distance of the vehicle beam 3 of the electric vehicle from the ground is between 460 mm to 580 mm.

### Embodiment 3

This embodiment provides a battery swapping station for electric light truck, the battery swapping station of this embodiment is the same in structure as that of embodiment 2, which focuses on the working principle, this embodiment further describes the battery swapping station for electric light truck with specific data.

In this embodiment, the battery swapping station is compatible with the battery swapping of the following vehicle; the wheelbase of the vehicle is not less than 3,300 mm, the outer distance of the vehicle beam is between 760 mm to 800 mm, the vehicle width is not more than 2,500 mm, the vehicle height is less than 3,500 mm, the vehicle weight is not more than 6 tons when fully loaded, and the distance of the center of the front wheel of the vehicle from the end of the battery pack is not less than 800 mm.

The height of the vehicle beam 3 from the surface of the battery swapping platform is 527 mm, the battery thickness is 220 mm, and the height of the locking base 51 from the surface of the battery swapping platform is 481. After the battery is installed on the chassis assembly, the height of the battery from the battery swapping platform is 300 mm, and the height of the battery swapping equipment 1 itself is 264 mm. After the battery is installed in the chassis assembly, the lower surface of the battery is 120 mm away from the upper surface of the tray for bearing the battery of the battery swapping equipment 1. The battery pack has a length of 1650 mm, a width of 1850 mm and a height of 220 mm, and the power consumption is between 80 kwh to 9280 kwh.

### Embodiment 4

This embodiment provides a battery swapping station for electric heavy truck, the battery swapping station of this embodiment is the same in structure as that of embodiment 2, which focuses on the working principle, this embodiment further describes the battery swapping station for electric heavy truck with specific data.

In this embodiment, the distance from the bottom of the battery pack to the surface of the battery swapping platform is 441 mm; the distance from the vehicle beam 3 to the platform of the battery swapping station is 800 mm; the height between the battery pack installed on the electric vehicle and the battery swapping platform is 405 mm; the maximum height of the battery swapping equipment 1 from the battery swapping platform is 390 mm; the distance between the lowest point of the vehicle beam 3 and the highest point of the battery swapping equipment 1 is 31 mm.

Although specific embodiments of the present invention have been described above, those skilled in the art should understand that these are only examples, and various changes or modifications can be made to these embodiments without departing from the principles and essence of the present invention. Therefore, the scope of protection of the present invention is defined by the appended claims.

What is claimed is:

1. An electric vehicle battery swapping assembly, wherein the electric vehicle battery swapping assembly comprises a battery swapping equipment and a battery pack box, both the battery swapping equipment and the battery pack box are arranged at a bottom of a electric vehicle, and the battery pack box is removed or installed from the bottom of the electric vehicle by means of the battery swapping equipment, during the removal or installation process, a height of the electric vehicle is unchanged, and a bearing plane for carrying the battery swapping equipment and a bearing plane for carrying the electric vehicle are in the same plane.

2. The electric vehicle battery swapping assembly as claimed in claim 1, wherein heights of the bottom of the electric vehicle and the battery pack box are set as follows:
when the battery swapping equipment removes the battery pack box, a height of the bottom of the battery pack box from the bearing plane for carrying the battery swapping equipment is greater than a height of the battery swapping equipment when it is unloaded;
when the battery swapping equipment installs the battery pack box, a height of the bottom of the electric vehicle from the bearing plane for carrying the battery swapping equipment is greater than an overall height of the battery swapping equipment when carrying the battery pack box.

3. The electric vehicle battery swapping assembly as claimed in claim 2, wherein the electric vehicle comprises a vehicle beam, and the battery pack box is detachable installed on the vehicle beam by means of a locking mechanism, and a height of a bottom of the vehicle beam from the bearing plane for carrying the battery swapping equipment is greater than the overall height of the battery swapping equipment when carrying the battery pack box;
preferably, the electric vehicle is an electric truck, and a battery pack box accommodating space is arranged between two sets of wheels of the electric truck along the driving direction, and a height of the vehicle beam at the battery pack box accommodating space is greater than the overall height of the battery swapping equipment when carrying the battery pack box;
preferably, the battery pack box is arranged below the vehicle beam or at least partially overlapped with the vehicle beam in vertical direction;
preferably, a locking point of the locking mechanism is arranged below the vehicle beam or at a side of the vehicle beam.

4. The electric vehicle battery swapping assembly as claimed in claim 3, wherein the battery pack box comprises a lower box and an upper cover, and the battery pack box is provided with a locking shaft which is detachable connected with the locking mechanism.

5. The electric vehicle battery swapping assembly as claimed in claim 4, wherein the locking shaft is arranged below a surface of the upper cover, a distance of the locking shaft from a highest position of the upper cover is h1, and a distance of a locking point from a bottom of the vehicle beam is h2, and h1 is less than h2.

6. The electric vehicle battery swapping assembly as claimed in claim 4, wherein the locking shaft is set higher than a surface of the upper cover, and a distance of the locking shaft from the surface of the upper cover is h3, when the battery swapping equipment carries the battery pack, a sum of a height of the upper cover from the bearing plane for carrying the battery swapping equipment and h3 is smaller than a height of a locking point from the bearing plane for carrying the battery swapping equipment;
or, the locking shaft is arranged higher than a surface of the upper cover, and a distance of the locking shaft from a surface of the upper cover is h3; when the battery swapping equipment carries the battery pack, a sum of a height of a surface of the upper cover from the bearing plane for carrying the battery swapping equipment and h3 is smaller than a height of a bottom of the installing bracket from the bearing plane for carrying the battery swapping equipment.

7. The electric vehicle battery swapping assembly as claimed in claim 5, wherein the locking mechanism comprises a locking base, and a depth of the locking base entering into the battery pack box is between 39 mm to 100 mm;
preferably, the locking base is installed on a side wall of the vehicle beam by means of an installing bracket, and a height of a bottom of the installing bracket from the bearing plane for carrying the battery swapping equipment is greater than an overall height of the battery swapping equipment when carrying the battery pack box.

8. The electric vehicle battery swapping assembly as claimed in claim 1, wherein the battery pack box further comprises an unlocking linkage mechanism, and the unlocking linkage mechanism penetrates through the battery pack box in a vertical direction.

9. A battery swapping station, wherein the battery swapping station comprises:
a battery swapping platform is used to park an electric vehicle for removing and installing a battery pack;
a battery swapping equipment is used for removing and installing a battery pack of an electric vehicle on the battery swapping platform;
wherein a height of a bottom of a battery pack loaded on the electric vehicle from the battery swapping platform is greater than a height of the battery swapping equipment when it is unloaded;
an overall height of the battery swapping equipment when carrying the battery pack box is smaller than a height of a bottom of the electric vehicle from the battery swapping platform.

10. The battery swapping station as claimed in claim 9, wherein the electric vehicle comprises a vehicle beam, and the battery pack is installed below the vehicle beam by means of a locking mechanism, and a height of a bottom of the vehicle beam from the battery swapping platform is greater than an overall height of the battery swapping equipment when carrying the battery pack box.

11. The battery swapping station as claimed in claim 10, wherein the locking mechanism comprises a locking base, and the locking base is internally provided with a locking groove for accommodating a locking member of the battery pack, and when the locking member is located in a locking position in the locking groove, the battery pack is locked on the electric vehicle;
preferably, the locking base is installed on the vehicle beam, and the locking groove is located below the vehicle beam, and an overall height of the battery swapping equipment when carrying the battery pack box is lower than a height of the locking groove from the battery swapping platform;
preferably, a height of a lowest position of the locking base from a surface of the battery swapping platform is greater than an overall height of the battery swapping equipment when carrying the battery pack box.

12. The battery swapping station as claimed in claim 11, wherein the battery pack comprises a lower box and an upper cover, and the locking member is a locking shaft.

13. The battery swapping station as claimed in claim 12, wherein the locking shaft is arranged below a surface of the upper cover, and a distance of the locking shaft from a highest position of the upper cover is h1; when the locking shaft is located in the locking groove, a distance between the locking shaft and a bottom of the vehicle beam is h2, h1 is smaller than h2;
preferably, a depth of the locking base entering into the battery pack is between 39 mm to 100 mm.

14. The battery swapping station as claimed in claim 12, wherein the locking shaft is set higher than a surface of the upper cover, and a distance of the locking shaft from a surface of the upper cover is h3, when the battery swapping equipment carries a battery pack, a sum of a height of the upper cover from the battery swapping platform and h3 is smaller than a height of a bottom of the locking base from the battery swapping platform.

15. The battery swapping station as claimed in claim 12, wherein the locking base is installed on a side wall of the vehicle beam by means of a installing bracket, and a height of a bottom of the installing bracket from the battery swapping platform is greater than an overall height of the battery swapping equipment when carrying the battery pack;
preferably, the locking shaft is set higher than a surface of the upper cover, and a distance of the locking shaft from a surface of the upper cover is h3, when the battery swapping equipment carries the battery pack, a sum of a height of a surface of the upper cover and the battery swapping platform and h3 is smaller than a height of a bottom of the installing bracket from the battery swapping platform.

16. The battery swapping station as claimed in claim 9, wherein the battery swapping platform is provided with a track for the driving of the battery swapping equipment, and a sum of a height of the track protruding from the battery swapping platform and a height of the battery swapping equipment when it is unloaded is smaller than a height of a bottom of the battery pack loaded on the electric vehicle from the battery swapping platform.

17. The battery swapping station as claimed in claim 16, wherein a sum of a height of the track protruding from the battery swapping platform and an overall height of the battery swapping equipment when carrying the battery pack box is smaller than a height of a bottom of the vehicle beam of the electric vehicle from the battery swapping platform; and/or, the battery swapping equipment is at least partially lower than an upper surface of the track.

18. The battery swapping station as claimed in claim 9, wherein the battery swapping equipment is installed on a battery swapping working position of the battery swapping platform, when an electric vehicle drives into the battery swapping platform in a first direction, a width of the battery swapping equipment in a second direction perpendicular to the first direction is smaller than a distance between left and right wheels of the electric vehicle;
and/or, the battery swapping equipment comprises a installing platform and an elastic mechanism arranged on the installing platform, the elastic mechanism is used for elastically supporting a battery pack; when a battery pack is carried on the elastic mechanism, the compression deformation of the elastic mechanism is s, and a sum of the height of the battery swapping equipment itself and the height of the battery pack itself is smaller than a sum of a height of a bottom of the vehicle beam of the electric vehicle from the battery swapping platform and s.

19. The battery swapping station as claimed in claim 9, wherein a lifting height of the battery swapping equipment ranges from 120 mm to 200 mm;
preferably, the battery swapping equipment lifts the battery pack by means of a cam lifting mechanism.

20. The battery swapping station as claimed in claim 9, wherein a floor of the battery swapping station is formed as the battery swapping platform;
or, a distance of the vehicle beam of the electric vehicle to the battery swapping platform is between 460 mm to 580 mm;
a difference between a height of the battery pack loaded on the electric vehicle from the battery swapping platform and a height of the battery swapping equipment is between 30 mm to 80 mm;
or, a difference between an overall height of the battery swapping equipment when carrying the battery pack box and a height of a bottom of the electric vehicle from the battery swapping platform is between 10 mm to 150 mm.

21. (canceled)

22. (canceled)
